(19) United States
(12) Patent Application Publication
(10) Pub. No.: US 2025/0204322 A1
(43) Pub. Date: Jun. 26, 2025

(54) HARVESTER HEAD WITH A CONTROL ARRANGEMENT OF A COLLECTOR-CONVEYOR MEMBER AND A MULTI-STAGE CONTROL BOX WITH GEARS THAT CAN BE USED IN THE CONTROL ARRANGEMENT

(71) Applicant: CARLOS MAINERO Y CIA. S.A.I.C.F.I., Bell Ville (AR)

(72) Inventor: Carlos Oscar Mainero, Bell Ville (AR)

(21) Appl. No.: 18/990,468

(22) Filed: Dec. 20, 2024

(30) Foreign Application Priority Data
Dec. 21, 2023 (AR) P20230103505

(51) Int. Cl. A01D 47/00; A01D 61/00

(52) U.S. Cl. CPC A01D 47/00; A01D 61/00

(57) ABSTRACT

A control for the endless set of a rotating harvester head includes a train of transmission stages that encircle on one side behind the gathering channel, rises upward to pass in a horizontal-transverse direction towards the medium above the tray in which the header-conveyors of the head are found, to finally be vertically lowered by a drop-down box that takes the axis of the augers. In turn, the drop box includes two reducing stages to oil-bath gears that concentrate much of the speed reduction coming from the power take-off at the inlet and, likewise, has a construction that reduces the interference in the passage of the harvest of the tray to the gathering channel. Patters located in the innermost turn of the auger on each side of the drop box can drive the crop to change 90° towards the gathering channel, further reducing interference when the flow rate is important.

### CROSS-REFERENCE TO RELATED APPLICATIONS

Not applicable.

### FIELD OF THE INVENTION

The present invention belongs to the technical field of agricultural machinery, which can be used in harvesting machines, particularly in collector heads, and concerns, in particular, the controls of the conveying organ of the collected material. Among multiple applications are, in particular, the mechanical controls for endless conveyors organs for sunflower rotating headers.

### BACKGROUND OF THE INVENTION

A harvesting machine generally includes replaceable and quick coupling headers to the machine that serve to collect crop material to be harvested and delivered for processing as it travels through the field. In its front part, some headers have cutting and collection members while others have only collection members, as appropriate.

After cutting or collecting, the material is collected and conveyed by the header to a narrow space in the middle of the rear of the chassis through which it passes to the machine that can accumulate or process it and lift it to an external hitch. There are various types of transport organs such as tapes or tarpaulins (drapers) and augers converging towards the middle of the header.

In a general type of harvesters, the mobile organs, between which the conveyor worm is located, are actuated by controls grouped inside a box mounted on one side of the header, typically the left (seen in the direction of advance of the harvester) or on both sides depending on the work type and width of the header, easily accessible for maintenance and where they do not basically interfere with the carry of the harvesting material inside the pan for the augers. A single common transmission extends, for example behind the pan, from the centralized power outlet of the traction machine to said side, traversing the lateral arm of the chassis of the header, where it provides rotary movement to the different moving members.

Said control mechanisms occupy a certain space that extends beyond the last end tray or tray supported on the corresponding side arm of the chassis, adding an unproductive width to the head (which can project 300 mm per side) that affects any adjacent row that is on that side, which remains unharvested, or even damaged, in the pass, requiring the harvesting machine to be oriented so that side is on the side of rows already harvested, which is not always possible or practical. Even though this problem in the field can be avoided, that unproductive width can interfere with machine maneuvers, such as with fencing when the last row is on that side, often glued to a fencing or in turns of the machine at the end of a group of rows to pass to a new group of rows (which cannot be contiguous to the freshly harvested if the first problem is to be avoided).

In addition, the protruding lateral width interferes with the possibility of harvesting with the same head in crops with distances between rows other than the distance between rows of the header and makes it impossible to harvest in multiple directions following harvesting methods that have been put into practice in the last decade and a half with corn harvester heads providing great benefits to the farmer.

By way of illustration, the FIG. 1 shows a known head for the mechanized harvesting of sunflower with a chassis formed by a rear frame 11 extending transversely to the forward direction and whereby the header is typically mounted on a harvesting machine, and two side arms 121 and 12D on the sides of the head attached to the respective ends of the rear frame 11 from where they extend longitudinally in the forward direction of the machine. In the chassis are mounted collector trays 13 supported by struts, the shield 14, the windlass 16 with its spikes helically distributed and superiorly shielded by the shield 14 and the cutting bar under the windlass 16 integrated by a series of blades commanded by a blade holder bar, the straddling roller with serrated vanes arranged on its perimeter, a transverse collector tray 17 fixed to the side arms 12 (alphabetical suffixes are omitted when generalized) of the chassis and extending from side to side of the head for transporting cut material from the crop towards a gathering channel 18 defined by a generally rectangular opening made in the rear wall of the tray 17 where the harvested material is poured into a gathering channel in a harvesting machine, and the transverse conveyor body, namely an conveyor towards the auger 19, arranged within the length of the tray 17 for smooth and orderly hauling the collected material towards the gathering channel 18 at the rear of the head.

FIG. 2 shows a control box 21 on the external side of the left side arm 121 of the head chassis of FIG. 1, indicating the driving force input bar 22 coming from the power take-off coupled to an input shaft 23 driving the shaft 24 of the conveyor auger 19 by means of chain 26 and the cutting bar by means of a crank mechanism 27 connected eccentrically to a pulley 28 driven by a belt 29. It also shows shaft 31 of the windlass 16 receiving the driving force through a chain 32 coming from the shaft of a hydraulic motor 33 located on the inner side of the side arm 121 of the chassis. FIG. 2 further indicates the unproductive (and disturbing) width A that the control box 21 adds to the outer side 22 on the left side of the header.

The control for the straddling body is located in a side box (not shown) on the right-side arm 12D of the head chassis. The control of the straddling body also adds an unproductive width to the right side of the head although essentially less given the mechanisms it houses (a single reduction transmission to a chain or belt).

The U.S. Pat. No. 11,425,860 (New Holland) discloses a harvester head that includes a collector auger extending transversely to the forward direction of the head and driven by a central control formed by a hydraulic motor mounted to the upper crossbeam of the chassis and a control wheel coupled directly to a middle portion of auger tube so as to eliminate hydraulic complications in augers driven at the ends thereof. The helicoid of the auger can be coiled around its tubular axis in opposite directions to either side of its midpoint and, inclusive, have an uncoiled middle section where it is driven by the control by means of a friction coupling behind the auger and exposed to the free air, with respect to which it discloses various alternative constructions, none of which can work acceptably in the field since, in all cases, they are coupled in the center of an auger that hauls all the collected material, which material will definitely stuck these controls quickly in crops with a high volume of material.

In the main embodiment of this patent, U.S. Pat. No. 11,425,860, said coupling of the auger with the hydraulic motor is based on smooth wheels with both parts lined with elastomers or rubber to improve traction. In a second embodiment, with a pair of smooth wheels similar and at 90°, one on the auger and the other on the drive motor arranged with its shaft parallel to the shaft of the auger with which it makes contact from above at a point that is not exactly in the middle but passing through one side of the gathering channel. Both constructions with a smooth wheel lack the necessary traction capacity to transmit the power required to a main auger responsible for transferring the entire collected material, such as that which is mounted on heads for sunflower or corn. Although this arrangement above makes it possible to circumvent or avoid interfering with the thickness of the harvested material, when it ends on the plane of the transversal conducting wheel to the transport direction of the auger, the area of the conductive wheel invading that space could be greater so that jamming could occur if the harvested material transported by the auger becomes sufficiently abundant.

A third alternative is gear coupling. The arrangement of this patent U.S. Pat. No. 11,425,860 (in all the constructions thereof) brings away the drawback of the conductive wheel, being friction or gearing, together with the fixed shaft attached to the rear, invading the space inside the tray where the harvesting material is transported, where they can produce accumulations and jams. Even when seeking to reduce this invasion by arranging the wheel or the gear with its plane parallel to the auger, the interference remains significant. This problem is more important in the specific case of sunflower turning heads due to the size of the cakes or harvested chapters. It should be assumed that, despite the years elapsed, this head has not reached a commercial state for these reasons.

As a subsequent development to the preceding appointment, international publication (WO) 2022/251,206 (New Holland) shows a head also with a hydraulic motor control associated with a transmission by chains or belts but in this case protected by a housing of no more than 4 or 5 inches (10 to 13 cm) in width, which solves the problem of exposed controls but presents the disadvantage of requiring the assistance of tensioners, which, given the scarce dimensions thereof, also make it very difficult to apply since the reduced length of the control belt or belt causes the maximum travel of the tensioner to be reached with little stretching. That is, it would require too frequent maintenance and after a few hours of work, it would remain without a path in order to absorb the stretching of the control element. On the other hand, and given its location and the scarce size of the housing containing same, said maintenance is uncomfortable and has little access. The same publication recognizes that the enclosure favors the accumulation of dust and pieces of material inside it where the crowns and chain work, thereby requiring it to be opened and cleaned at a certain moment by the operator.

Due to the reduced dimensions of the drop control box, by using chains or belts, there is no significant reduction in speed within it, so by having a hydrostatic drive ensures the possibility of adjusting the input speed in order to achieve the final speed of the auger (between 100 and 200 rpm) without the need for significant reductions in the drop box.

This body, with an auger split at a mid-point where it is driven by a crown located behind the auger with its shaft parallel to the shaft of the auger, is between both augers rotating in opposite directions, occupying—as well as the preceding appointment—part of the space in front of the gathering channel just where the harvested material that is being transported by the auger must suddenly change direction (90°).

It should be added that, in both backgrounds cited of New Holland, the primary power source for the auger comes from a hydraulic, electric or similar motor, which makes it easier to regulate the rotation speed (RPM) of the auger body and, therefore, the speed of transfer of harvested material towards the gathering channel regardless of the rotational speed of the mechanical drive of the harvesting machine to the head.

On the other hand, heads or platforms are known with rigid or flexible, flat or serrated, straight or curved blades, etc., fixed to the tube of the auger in the central area thereof for the purpose of taking the material and assisting the spirals in the work of changing their direction backwards and delivering it to the gathering channel. In some situations, the material does not move sufficiently to reach the gathering channel due to the action thereof, which manifests itself in the piling up of material in the front thereof which forces the operator to reduce the forward speed and in others, tend to return the material forward due to excessive aggressiveness, resulting in crop losses or at least deficient work. In some cases, in order to avoid material losses, covers are placed in the center of the auger and above it which serve to tackle the returned material and deliver it back to the center of the auger.

Another system for assisting the auger in order to change the direction of advance of the material and deliver it backwards to the gathering channel once it reaches the center thereof is the one known as a retractable finger system in which fingers mounted inside the tube of the auger on an eccentric shaft move outwards, coming out of the same in the front part of their travel and inwards at the rear, but requires large-diameter tubes so that it is only mounted on some specific heads that require, for any additional reason, large-diameter auger tubes. Another disadvantage thereof is its high constructive cost.

Other method or system for assisting the auger in order to change the direction of advance of the material and deliver it backwards to the gathering channel once it reaches the center thereof, consists of serrated edges on the perimeter of the propellers in said area, which has the advantage of its low constructive cost but the disadvantage of being too aggressive under some conditions, resulting in the return of material towards the front.

Background to the art can be seen: DE 102/4.033.089 A1; U.S. Pat. Nos. 2,426,922; 2,464,919; 2,755,912; 2,978,097; 4,300,333; 4,550,554; 4,972,665; 6,093,099; 6,561,896; 6,640,527; 9,578,806; 10,154,625 and US 2019/313,581 A1.

U.S. Pat. No. 3,412,535 (Int Harvester) is another known antecedent, of less relevance.

### SUMMARY OF THE INVENTION

A primary objective is to get rid of, from the outside of the panel (right and left) of the head chassis, to the movable body controls to eliminate or substantially reduce the unproductive width existing on that side of the head where the mechanical controls of the moving bodies are conventionally mounted. A main part of the solution arises from creating controls lodged in intermediate sites of the head within the width of the head (defined by the harvester-collector bodies themselves) without crossing any of the end side panels.

In the particular case of heads for sunflower, another of the benefits of reducing the width of the heads on both sides, fundamentally the right (side which describes on the crop side without harvesting in its normal working path), is to extend the applications of these heads to allow crops to be harvested with varied inter-row spacings or in oblique directions relative to those of the rows, i.e. to adapt the heads for multiple distances and directions, currently difficult due to the problem of the width on the sides directly related to the controls.

Another objective within the primary is to relocate the controls of the moving bodies in a more centralized location but in such a way that it does not cause an interference problem with harvesting and hauling the harvested produce to the gathering channel, more particularly avoiding hindering the operation of the conveyor bodies (augers) and the passage of the harvested produce (by the tray to the analog) towards the gathering channel, precisely in the middle area of the conveyor body (auger) where the transfer of the harvested material changes direction (90°) towards the gathering channel. In doing so, the present invention counteracts the contrary myth to occupy space in the area of the gathering channel.

These objectives are achieved with a control for the conveyor body (auger set) which extends through the central area in front of the gathering channel but preventing or, at least, substantially minimizing interference with the material carried by the collectors in the central area where the flow of material changes direction (at 90°) to enter the gathering channel. According to a first feature of the present invention, the control lowers substantially from above into the connection with the harvested material conveying body in an intermediate region of the harvester head, close or coincident with the theoretical longitudinal mid-plane of the head.

Another problem addressed by the present invention is the adaptation of the harvester head to different models of harvesting machines provided with power outlets with different speeds, which requires changing the transmission ratios to the conveyor auger. It is convenient to structure this final stage of the control with a constant take-off airtight drop or control box located above the middle area of the auger, occupying a minimum of space above the middle area of the tray where it does not generate interferences in the normal traffic of the material and ensures a maintenance-free operation, very important in a poorly accessible or uncomfortable location.

A secondary feature of the present invention is that the drop-down box can contain a reducing mechanism (such as gears in water or oil) with an important drive ratio in order to provide most of the transmission reduction. The drop-down box to gears at constant take-off may have more than one reduction stage within the same box to incorporate most of the power take-off speed change to the collector-conveyor body. It is worth noting that the power take-off of the harvester typically rotates between 500 and 950 RPM while the rotation rate of the auger typically varies between 100 and 200 RPM, so the required speed reduction is usually important.

Another secondary feature of the present invention is that the transmission ratio of the drop box is constant such that the change in the transmission ratio can be made with a minimum adjustment of speeds by means of a simple change of pulley or toothed wheel in the rear part of the head where the control is connected to the power outlet. This ensures that it can be used in any type of head—even in those that do not have a self-hydraulic group—and in any type of application of the auger, whether this is the means of main transfer of the material or accessory, such as in the case of “draper” or platforms to the tarpaulin.

On the other hand, in order to use the power take-off of the harvesting machine in order to propel the collecting body it is possible to prevent the control, which has an input stage with coupling to the power take-off of the harvesting machine, located in a lower plane than the gathering channel of the harvester, hindering the gathering channel behind it, interfering with the output of harvested material to the harvesting machine. According to a second feature of the present invention, this control includes a train of transmission stages arranged to surround the gathering channel on one side behind it, which starts at the power outlet of the head, rises towards the top of the chassis, deflecting towards one side of the gathering channel so as not to hinder the passage of outgoing harvested material from the tray, so as to pass above the tray to the drop box.

The control of the augers comprises a train of stages or transmissions from the power take-off to beyond the gathering channel of the augers to the harvester, then changes direction upwards to a height higher than the gathering channel and the conveyor auger where it switches back to a horizontal direction towards the medium above that gathering channel and conveyor where it is transmitted vertically downwards to take the shaft of the augers by means of the drop box.

It is convenient to bend the thickness of the control box or down box with which the conveyor auger is coupled so that, the thinner, it reduces the length of the augers in addition to not hindering the passage of material conveyed towards the gathering channel. At the same time, it is an objective to concentrate in the drop box all or much of the speed reduction required between the power take-off of the harvesting machine and the conveyor body. A problem with the present invention is to accommodate gear-reducing stages, where the difference between the sizes of the gears to be taken are significant, within a housing of little width or thickness, avoiding problems in transmission such as excessive pitching. The present invention solves the problem of providing a constructive solution to this problem by means of a system for fixing the mallets to the gears up to the point that allows a reduction of two stages of gears inside a housing of less than 125 mm, preferably less than 100 mm in thickness or width (in the direction of the length that it occupies on the conveyor body.

In order to obtain a gearbox with a high transmission ratio and which is sufficiently narrow in relation to the torque and power parameters that must be transmitted to the auger assembly, another object of the present invention is a gearbox for the lowering stage. The high transmission ratio caused at least two reduction stages while the reduced width of the box required thin gears involving problems of oscillation, pitch and concentricity. In order to solve these problems, the gears, at least the intermediates, are threaded on their shafts and then glued with adhesive, with or without a hub between the gear and the shaft. The pair of gears mounted on the same intermediate shaft may be threaded and glued to a threaded common hub integral with the shaft.

In combination with the feature of the present invention, the controls of the mobile bodies are relocated in a more centralized location, on the other hand it is proposed to incorporate a baffle-type deflector element attached to the propeller of the auger where it faces the gathering channel, formed with a specific orientation and thickness to drive material from the crop in the direction of the gathering channel, thereby assisting in changing smoothly the direction of 90° of direction. At the same time, these deflecting elements, which are located in the innermost turn of the auger on each side of the drop box, are related to the aforementioned objective of avoiding hindering the passage of the crop towards the gathering channel, removing the crop material more quickly from that area, assisting the augers effectively in the task of changing the direction of advance of the material in the center thereof and collaborating in its transfer back to the gathering channel, capable of working in the greatest quantity and variety of possible crops, while preventing part of the material from being returned to the front, helping to compensate for the reduction of the length to the auger in the middle of the opening due to the relocation of the auger gear in the center, preventing a bottleneck and avoiding congestions when there is a large quantity of harvested material.

Said baffle-type deflector element comprises fingers, which can be round or faceted, solid or not, which are attached to the transfer face of the spiral from its base, i.e. the tubular shaft, to its outer end. The fingers are mounted at an angle with respect to the radial and in an amount sufficient to cover the total width of the gathering channel of the harvester, preferably being straight in an inner part of its travel and taking an additional angle in its outer part tending to its parallelism with the tangent of the circumference of the auger, with the aim of achieving efficient transfer and preventing, in turn, that part of the material is retained therein and returned towards the front of the head.

According to another accessory feature of the present invention, the control for the straddling unit is located at the end of the head but relocated from the inner side of the side panel of the head so as not to add or contribute to the width of the head. The driving force for the straddling unit can be taken from one end of the auger.

### BRIEF DESCRIPTION OF DRAWINGS

Both the main object of the invention and the advantages achieved can be seen in the following description of a preferred embodiment, with references to the attached figures, in which:

FIG. 1 is a front-side perspective view of a known sunflower harvester head, the side of which exhibits the previously mentioned unproductive width.

FIG. 2 is a left side elevation view of the chassis of the conventional sunflower harvester head of FIG. 1 with its side panel to illustrate an arrangement of controls of its movable bodies.

FIG. 3 is a rear perspective view showing a sunflower harvester head with a centralized control of the collector auger according to a preferred embodiment of the present invention, the structural parts of the head being transparently represented in order to visualize the control more clearly.

FIG. 4 is a top-front perspective view of part of the head of FIG. 3.

FIG. 5 is a left side sectional view showing the arrangement of the stages of the central control in the harvester head of FIGS. 3 and 4.

FIG. 6 is a perspective view of the train of transmissions to the drop box including the central control of the collector auger of FIGS. 3; 4 and 5 extracted from the rest of the head for clarity.

FIG. 7 is a left side elevation view showing the arrangement of the intermediate and final stages of the central control in the harvester head of FIGS. 3 and 4 extracted from the rest of the head for clarity.

FIG. 8 is a front perspective view of the drop box of the central control of the collector auger illustrated open for allowing the double reducing stage to be seen therein.

FIG. 9 is an breakup perspective view showing assemblies of gear assemblies drawn into shafts of the drop box of FIG. 8;

FIGS. 10 and 11A are elevation and cutaway views, respectively, viewed from the major gear side, of a gear set attachment system intermediate to the shaft via hub in the drop box of FIGS. 8 and 9 in accordance with an advantageous feature of the present invention.

FIG. 11B is a analogous view to FIG. 11A showing an alternative embodiment of the intermediate gear attachment system to the intermediate shaft of the drop box of FIG. 8;

FIG. 12 is an breakup perspective view of the double intermediate gear assembly of the drop box of FIGS. 8; 9; 10 and 11A;

FIG. 13 is an elevation view of the drop box of the control for the collector-conveyor body where its reduced thickness dimensions are indicated.

FIG. 14 is a plan view of one of the collection augers with a baffle or deflector device to improve crop flow to the gathering channel.

FIG. 15 is a section along plan A-A of FIG. 14.

Lastly, FIGS. 16 and 17 are perspective views, left side, front and rear, respectively, of the left side of the head with a control of the straddling unit combined with the control of the auger according to the present invention.

In all the figures, equal references correspond to the same or equivalent elements of the head.

### DETAILED DESCRIPTION OF THE INVENTION

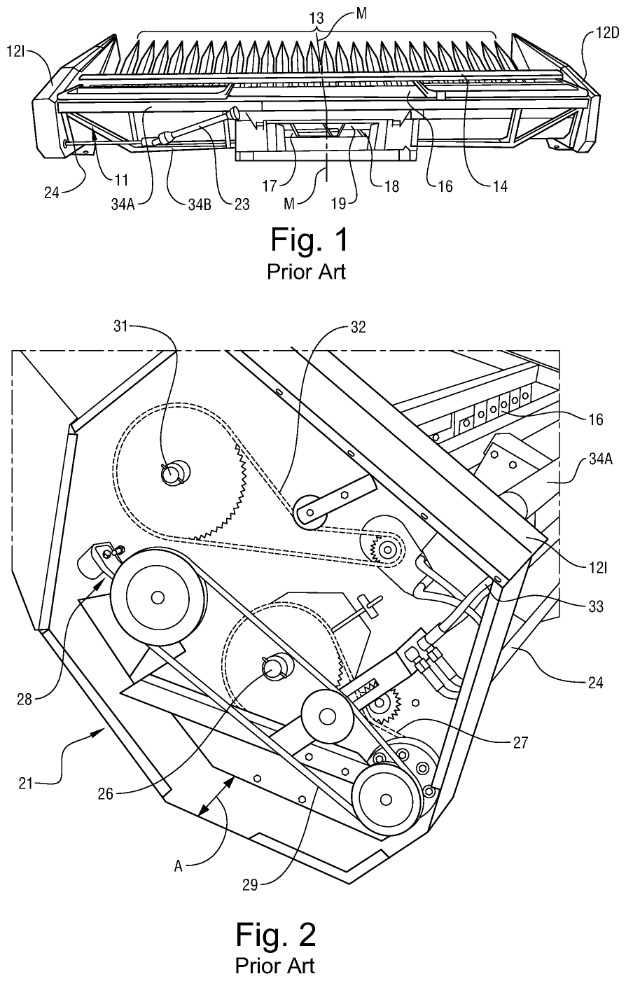

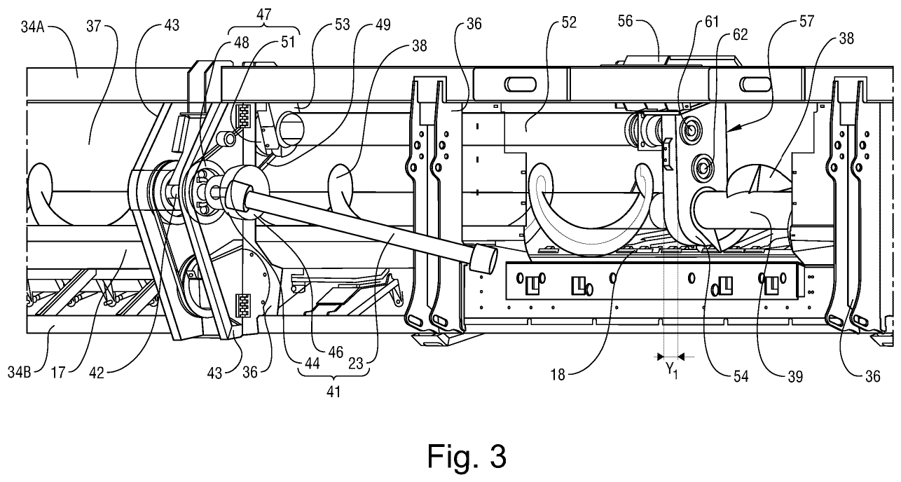

The head exemplified in this detailed description is intended for the harvesting of sunflower and comprises a chassis with a rear frame 11 structured with an upper crossbeam or crossbar 34A and a lower transverse crossbar 34B joined together by columns 36 at determined intervals that support a spallback 37 in the rear part of the head. The crossbars 34 are tubular with a rectangular cross-section. As in the known head of FIG. 1, the collector-conveyor body in the sunflower head exemplified in FIG. 3 below comprises an auger assembly 19 arranged horizontally and transversely inside a tray 17 for transporting the sunflower collected from the trays 13 to a gathering channel 18 formed in the spallback 37 where a gathering channel of a harvesting machine is coupled.

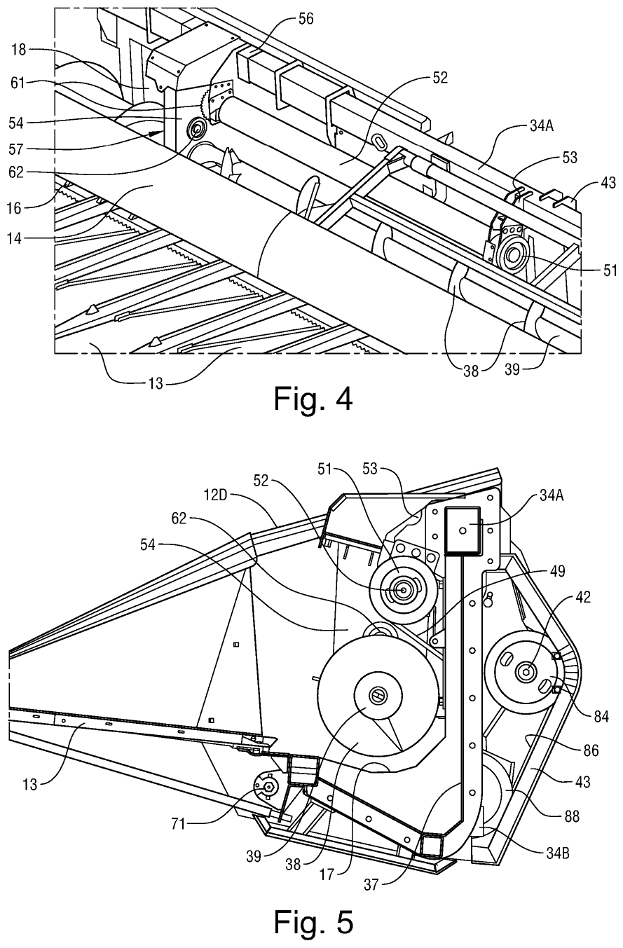

In this embodiment of the sunflower head shown in FIGS. 3 and 4, the auger conveyor-conveyor assembly 19 comprising two coaxial augers 191 and 19D, one on each side of a theoretical longitudinal mid-plane M of the head, with helicoid blades 38 wound in opposite directions on linear axial cylindrical blades 39 that rotate synchronously in the same direction, mounted on a common shaft commanded by a control arrangement according to the present invention. In another embodiment, the conveyor assembly may comprising augers rotating in opposite directions. Said theoretical longitudinal plane (or axis) is a theoretical longitudinal median plane M of the head, such as to an imaginary plane (or axis) equidistant from both end side trays 13′ of the harvester head.

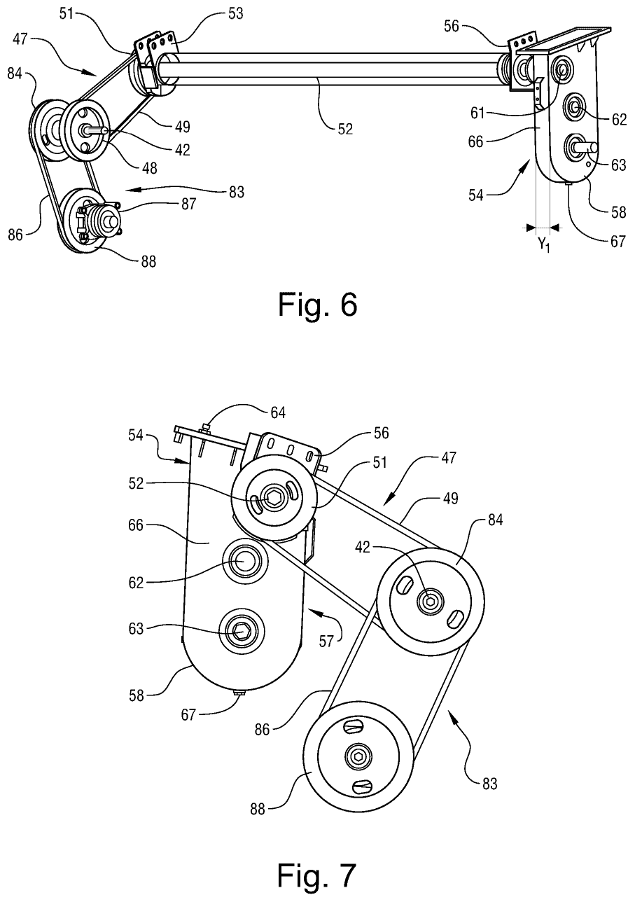

FIGS. 3 to 7 show the control arrangement that controls the conveyor/conveyor auger 19 from a power outlet of the harvesting machine on the rear part of the harvester head, at a lower level than the gathering channel 18 as seen in FIG. 3. The control input bar 22 is connected to the power take-off (RPM output) located on the side of the gathering channel 18 and on which the head is mounted.

According to the present invention, the first transmission stage 41 of the control arrangement includes an intermediate shaft 42 mounted between two vertical walls 43 of a support and distribution structure or box (open) fixed to the rear crossbars (spallback) 34 against one of the columns 36 of the chassis. This intermediate shaft 42 has an end outside of the support structure 43 connected by a universal joint 44, provided with a guard 46, to the control input bar 22 as can be seen in FIG. 3 to copy the rotary motion of the harvesting machine connection.

From said intermediate shaft 42 the driving force is distributed over several branches, namely:

### Control Branch for the Auger Collector-Conveyor Body 19:

This branch is started in the second stage 47 of the control with the pulley 48 on the right of the intermediate shaft 42 which, by means of a V-belt 49, is connected to a receiving pulley 51 located further up and later that the first 48. The control branch for the augers for the purpose of the present invention proceeds with the receiving pulley 51 mounted on the external end of a spallback shaft 52 (FIG. 4) where it is supported by a bearing on a support 53 fixed to the chassis of the crossbeam 34A. This spallback shaft 52 is extended in a horizontal direction transverse to the medium, parallel to the collector-conveyor auger 19, at a location above and slightly rearward thereof, ending at an inner end that connects directly to a central control drop box 54 mounted in vertical registration with said theoretical median plane M of the head. The supports 53 and 56 at both ends of the spallback shaft 52 are fixed to the front face of the upper crossbar or rear crossbeam 34A of the chassis.

The drop box 54 houses the final stage 57 of the control arrangement of the collector/conveyor augers 19. At its lower part 58 it receives the internal or medial ends of both augers 19, embracing them, in order to impart them the rotational movement transmitted by the spallback shaft 52 at a suitable speed (FIGS. 5; 6 and 7). In this way, the control arrangement arrives higher than the gathering channel 18 (located in a middle area between both sides of the harvester head and through which the harvested material transported by the tray exits) and out of the passage of harvested material that exits backwards of the tray 17, complying with a primary objective of the present invention. The drop box 54 has its bottom part 58 rounded down, ideally semi-cylindrical concentric with the shaft 24 of the auger 19, which penetrates into the tray space 17 and is located in front of the center of the opening of the gathering channel 18, where the harvested material that flows from both sides must necessarily change back and forth to leave the head. In this way, a centered control is obtained for the collector-conveyor auger 19 which does not interfere with the gathering channel 18.

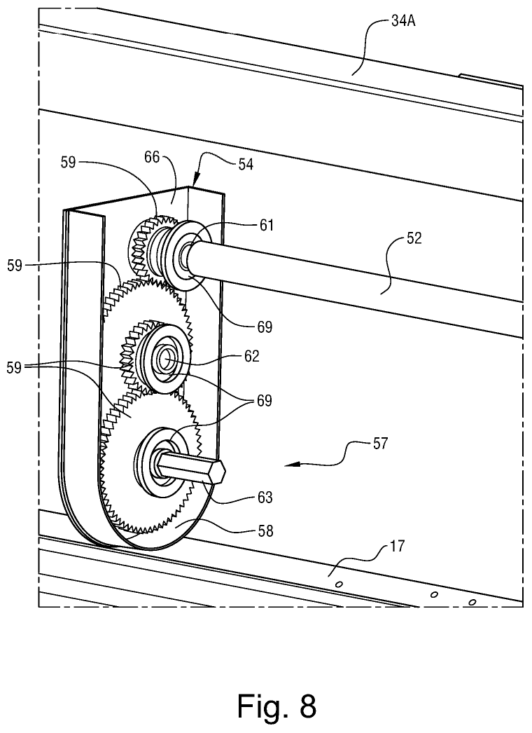

According to another feature of the present invention, the drop box 54 is by gears 59 in constant oil bath intake with two reduction stages as shown in FIG. 8. Considering that the control regime to the head of the current harvesters varies between 500 and 950 rpm, 620 to 640 rpm being the average value to which the modern machines are lying, a regime of the order of 5:1 OR 6:1 is chosen, that ensures a reduction of an important magnitude (specified within a range of 80 to 100% of the total reduction throughout the control) within its contents dimensions and facilitates the adjustment of that regime with little difference between pulleys 48-51 and arrive at the extreme values (500 and 950 rpm) with pulley diameters 48-51 that physically supports the available physical space, which resolves, in an integral way, the problem of allowing a simple and accessible speed adjustment consisting in changing the set of pulleys 48-51 of the second control stage by some of the appropriate diameter to the power take-off regime of each make and model of harvesters. The set of pulleys 48-51—at least one of these can be part of a kit for adapting to the harvester that will actuate the head, varying according to each make and model, while the drop box 54 is part of the head and, therefore, the same for all harvesters.

### Drop Box 54:

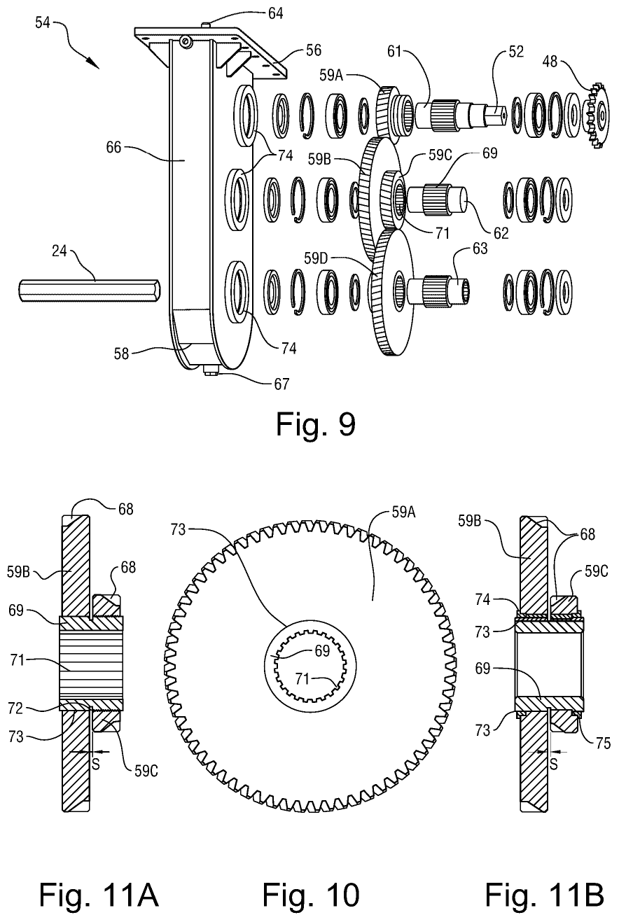

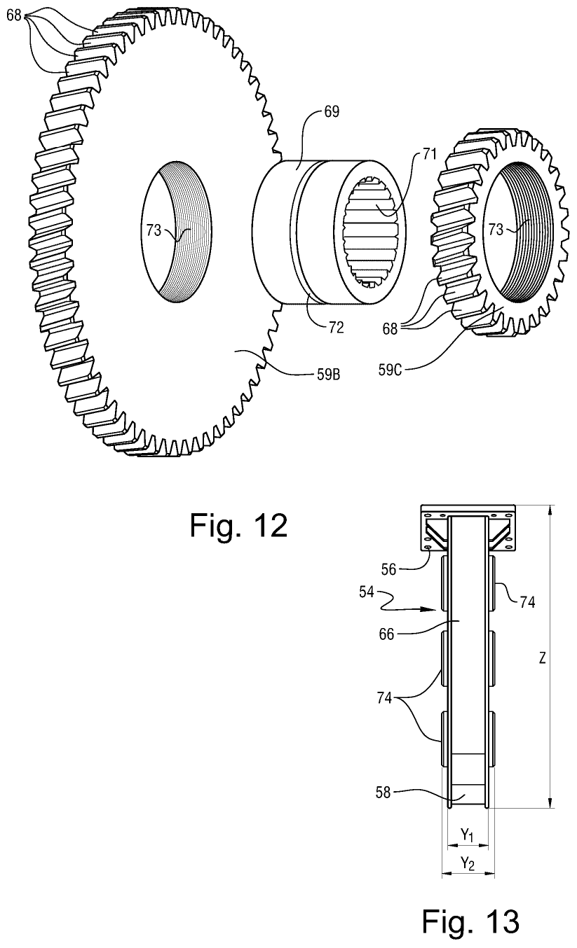

Internally, the drop box 54 has three parallel shafts 61; 62 and 63 to the axis 24 of the auger 19 on which the four gears 59 forming the two mentioned reduction stages are mounted, as detailed in FIGS. 8 and 9. The upper input shaft 61 is mounted on an internal hexagonal end of the spallback shaft 52 (or by a shaft that fits integrally within the spallback shaft 52) that passes through a hexagonal hole made in the upper gear 59A, the intermediate 62 integral with two intermediate gears 59B-59C while the lower output 63 is the meeting at the abutment of the internal ends of both augers 19, which simultaneously conducts by means of the lower gear 59D mounted on that shaft 63.

The drop box 54 is hermetic and contains lubricating oil in which the gears 59 of the two reduction stages are immersed, the level of which can be controlled and refilled through a plug 64 provided in the housing 66 of the drop box 54. In the lower part 58 of the housing 66 there is another plug 67 for changing the lubricating oil.

According to another feature of the present invention, illustrated in detail in FIGS. 10; 11A and 12, the pair of intermediate gears 59B-59C are attached to their common axis 62 by a fastening system that ensures low pitching of the gears 59 and achieves that the thickness y1 of the housing 66 of the drop box 54 is only 93 mm and the total maximum thickness y2 between its cakes 68 is 121 mm.

The requirements of the transmission box 54 are particularly demanding from several viewpoints:

It is located in the area where the entire collected material circulates and just where the change of direction that drifts it to the harvester occurs, so the space occupying fundamentally its width, is crucial to avoid obstructions or restrictions to the flow of material.

The relationship between the input and output regime is convenient to achieve a reduction close to 5:1 or 6:1, since the control regime to the head of current harvesters varies between 500 and 950 rpm, 620 to 640 rpm being the average value to which they are spreading out. A 5:1 reduction allows this regimen to be adjusted with little difference in diameter in the control elements of the first transmission stage 41 (pulleys 48 and 51 in this case, but could be gears) and reach both end values (500 and 950 rpm) with diameters of said physically admissible elements 48 and 51 in the available space. Since the pulley 48 (or 51) is part of the harvester adaptation kit that will actuate the head and varies according to each make and model, as described above, it is a goal that the replacement of that single pulley 48 (or 51) is sufficient to adjust the speed of the auger 19 to the harvester control, while the rest of the transmission stages, including the drop box 54, are standard part of the head and hence the same for all the heads.

A reduction greater than 5:1 involves two reduction stages to be housed in a box with a width of less than 100 mm, whereby the support of the gears 59B or 59D on the control shaft 62 or 63 is reduced for both the diameter of the gears 59B and 59D, increasing the risk of pitching in the event that the clearances in the attachment between shafts 61; 62 and 63 and gears 59 allow it.

The output torque required to drive the augers 19 is 2,000 N/m. In order to allow and simplify the assembly thereof, few are the systems for fixing between shafts and admitted gears that also ensure, furthermore, the necessary transmission of power and torque.

The transmission consists of four gears 59 of helical teeth 68, all having a thickness of 24 mm, the two smaller having 28 teeth, a normal module 4 mm, an outer diameter of 124 mm, a pressure angle of 20° and a helix angle of 15°. One of the smaller gears is left-handed helix and the other right-hand propeller. The two larger gears are 63 teeth, the same module and an outer diameter of 268.9 mm, the constructive features are the same and in the same way there is one of left propeller and another right propeller.

In order to extend its support base, the two gears 59B and 59C of the intermediate shaft 62 are mounted on a single hub 69 of 55 mm wide with a flat root groove 71 with a lateral adjustment of 24 teeth and a pressure angle of 30° by means of which they are connected to the intermediary shaft 62, as illustrated in FIGS. 10 and 11A together. Due to its outer parts and in the center thereof, the hub has two stops each materialized by a Segger DIN 471 80 mm diameter ring placed in grooves 72 that allows locating both gears 59B-59 C with the correct separation S, while the attachment between said hub 69 and the gears 59B and 59C is by means of a fine Whitworth thread 73 of 3¼×14 wires/inch (approximately 82½ mm×5½ threads/cm) so that, when rotating, the gears 59B-59 C are fitted thereon.

In this preferred embodiment, the input gears 59A and output 59B are mounted in an analogous manner to a thread and an adhesive on internally splined hub positioned on the upper and lower gears 61 and 63 of the drop box 54.

In this way, both gears 59 of each reducing stage are screwed onto a hub until they stop in the separator (Seger ring) with a left thread and opposite to the normal direction of rotation so that, when rotating, it tends to be adjusted while keeping the assembly assembled. On the other hand, by forming between the three parts a substantially solid and non-play assembly, which rests in a width of more than double (55 mm) in width than each gear (24 mm), practically eliminating the possible oscillations of the assembly. Furthermore, by joining the three parts (major, minor gear and spline-threaded hub) in a single assembly and since both assemblies are connected by their helical teeth 68 to each other and have each pair of gears of the same set of opposing propellers, the trends to oscillate each other are counterbalanced.

FIG. 13 shows the final dimensions of the housing 66 achieved with the prescribed features of the drop box 54 with its two stages of reduction and sets of stuffed gears, achieving that the thickness y1 of the housing 66 is only 93 mm and the total maximum thickness y2 between its mallets 74—within which the bearings of the shafts 61 are housed; 62 and 63-121 mm, the reduction being significantly achieved by the thickness y1 in the lower part 58 of the housing 66 due to its proximity to the grain carried by the auger 19. The height Z of the drop box 54 is 705 mm.

It should be added that, because the head can rotate in the opposite direction in the event of jamming, to prevent the gears 59 from unraveling, they are glued to the hubs 69 with special glue for high strength threads. In other words, the normal rotation (working direction) is perfectly secured by the left thread, while the reverse rotation direction, for sporadic and short use (unclogging) is secured by an excess capacity glue.

A variant option to the female threading of the gears 59 is a threaded sleeve 75 on the intermediate hub 69, introducing its body onto a machined recess 76 in the gears 59 so as not to alter the width of the box, as illustrated in FIG. 11B. Its use facilitates eliminating alignment errors of the threads 73 of the intermediate hub 69, enables the use of cotter between gear 59 and hub 69 while not increasing the thickness y1 of the box 54.

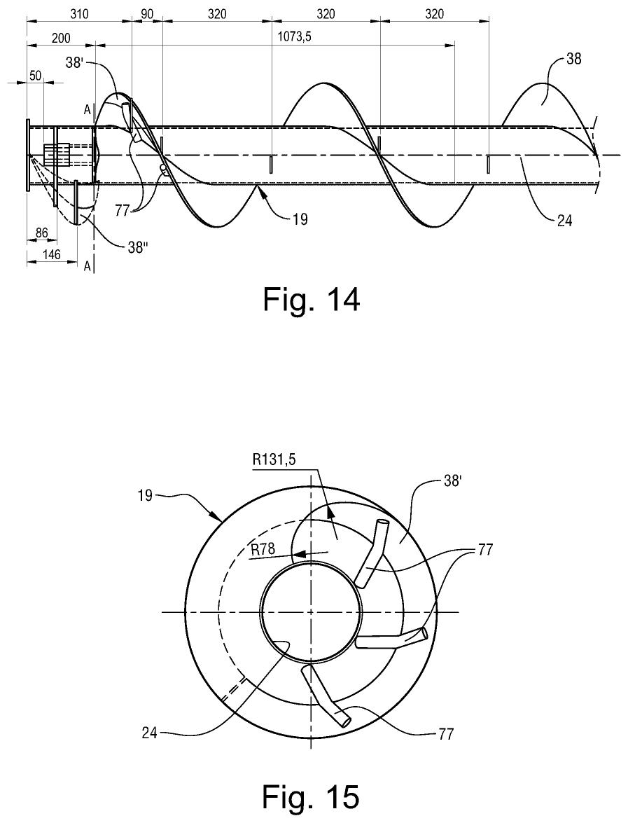

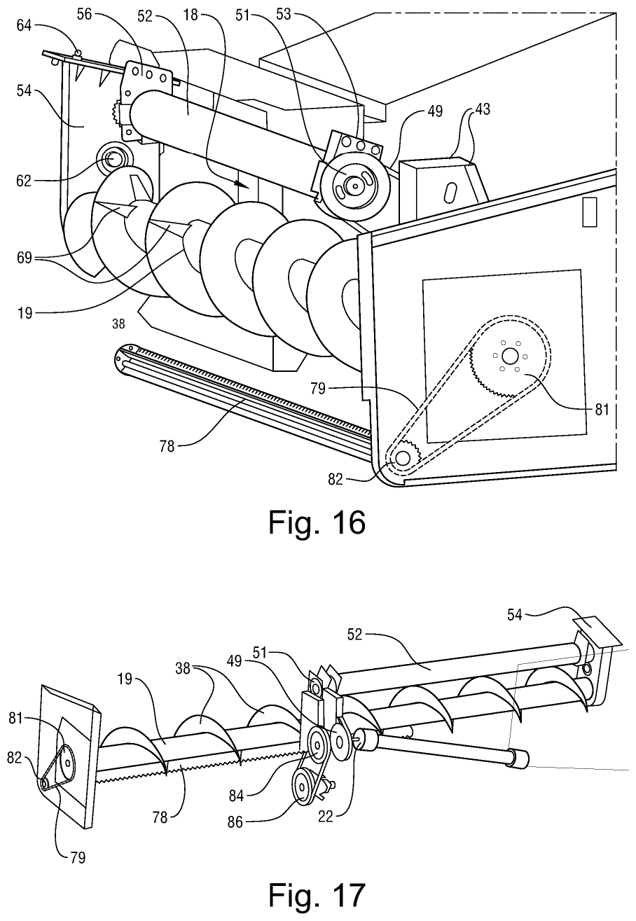

On both sides of the drop box 54 the innermost turn 38′ of each of the augers 19 has a baffle-type deflector element 77 where it faces the gathering channel 18, in order to push the material carried by the auger 19 in a direction perpendicular to which it moves. Each deflector element may comprise a solid round finger 77 welded to the turn 38′ adjacent to the drop box 54 of each respective auger 19, as shown in FIG. 14, so that the deflector 77 is displaced towards the gathering channel 18 with each rotation of the auger 19, helping to compensate for eventual bottlenecks caused by the finite thickness Y1 of the drop box 54. As can be seen in FIG. 15, the fingers 77 are straight in about ⅔ the course of their travel, forming an angle of 30° with respect to the radial direction, and they take an additional 15° angle in the outer third thereof tending to their parallelism with the tangent of the circumference of the auger 19 to achieve efficient transfer and, in turn, prevent part of the material from being retained therein and returned towards the front of the head. The outer ends thereof are mounted such that their outer ends are at about 200 mm apart from each other, starting from the central end of the spiral and in an amount sufficient to cover the overall width of the gathering channel 18, including in the counter-turn 38 of the helix 38.

As described and illustrated, it can be seen that the train of stages that make up the control arrangement fulfill several purposes, namely: The first control stage 41 (comprised of the input bar 23 and the intermediary shaft 42 interconnected by the universal joint 44) carries the transmission of the control (rotary movement) towards one side so as not to interfere with the head of the head; the second control stage 47 (pulley system 48-49-51) raises the rotary movement of the transmission of the control to a level higher than the tray 17 and towards the auger 19 although essentially outside through which the harvested material carried by the auger 19 passes inside the tray 17; the third control stage 52 (spallback bar 52) carries the control towards the means M of the head and places it in vertical registration with the ends of the augers 19 on either side of the head; and, finally, the drop box 54, which houses the final step of reducing the control arrangement for the collector-conveyors 19, connects to the auger shaft 19 (in the theoretical median plane M of the head) and leads it to a specified speed (for example 200 RPM approximately). In addition, the housing 66 of the downcomer 54 desirably has minimized its bottom 58 that penetrates into the tray 17 where it is located in front of the center of the opening of the gathering channel 18, where the harvested material that flows from both sides must necessarily change rearward direction for egress of the head. In this way, a centered control is obtained for the auger conveyor-conveyor body 19 which does not interfere with the gathering channel 18, allows the transmission of the control to pass first behind the auger body 19 and then rise forward to a point above the auger body 19, always vertically towards one side at the sufficient distance from the theoretical median plane M of the head to encircle the gathering channel 18.

### Control Branch of the Straddling Unit 78:

The control of the straddling unit is located on the left side of the head which, by means of a chain transmission 79 links the left auger 19 with the strainer 78, thus being connected by means of a fixed mechanical relationship. FIGS. 16 and 17 show the inner side of the head devoid of its cover panel to reveal the transmission by means of a conductive toothed wheel 81 at the end of the shaft 24 of the auger 19 passing through the left wall of the chassis and a gear wheel 82 driven at the end of the straddling unit 78.

### Control Branch for the Cutting Bar:

This branch 83 is initiated in the pulley 84 on the left of the intermediate shaft 42 (FIGS. 3; 6 and 7) and, by means of a V-belt 86, is connected to a control box 87 which transforms the rotational movement of the transmitter pulley 88 into an oscillating linear movement which, by means of an attached arm and cam system (FIG. 15), transfers the reciprocating movement to the cutting bar (not illustrated).

In said support and distribution structure shown in FIGS. 3 and 4, a second pair of pulleys is housed and linked by a V-belt that derives part of the rotational power towards a centralized control for the blades in the cutting bar by means of a bar whose rear end is eccentrically connected to the receiving pulley to describe an alternative longitudinal movement below the tray 17 to actuate the cutting bar by means of a lever or cam mechanism. To this end, a mechanical arrangement similar to that published in Canadian patent (CA) 2,951,302 (Honey Bee) can be incorporated with movement converter and direction change mechanisms such that it is not shown or described in more detail in this specification.

A particular embodiment of mechanical controls for the conveyor-conveyor auger 19, the straddling unit 78 and the cutting bar are described above in a rotating harvester head without detriment that changes in materials, shapes, dimensions, geometry, transmission ratios, speeds, construction, application and arrangement of the components may be practiced without departing from the scope of the present invention defined in the claims that follow. It is evident that there are innumerable variants and ways of configuring and arranging the different stages of the train of transmissions that make up these controls. For example, the invention described in terms of controls can be applied to heads or machines for harvesting other crops such as maize, for example. In addition, the disclosure is particularly related to an auger assembly 19 as a collector-conveyor body without detriment to the application of the present invention with other types of conveyor organs with analogous problems (such as drains or conveyor belts) actuated with mechanical driving force from said power take-off.

1. A harvester head with a control arrangement of an assembled collector-conveyor organ in the harvester head for transporting harvested material poured into the collector-conveyor organ towards a gathering channel arranged in a middle area of the harvester head through which the transported harvested material exits backwards; wherein said control arrangement of the collection-conveyor organ terminates in a drop box that is coupled in a constant manner from above to the collector/conveyor organ in the middle area of the harvester head.

2. The harvester head of claim 1, wherein the drop box contains a reducing mechanism and is located above the collector-conveyor organ.

3. The harvester head of claim 2, wherein the drop box is hermetic and the reducing machine comprises gears in constant transmission relation in an oil bath within the drop box.

4. The harvester head of claim 2, wherein the reducing mechanism has two reduction stages.

5. The harvester head of claim 3, wherein said constant transmission ratio is on the order of 5:1.

6. The harvester head of claim 2, wherein the drop box terminates below in a semi-cylindrical portion about the axis of the collector-conveyor organ.

7. The harvester head of claim 1, wherein the drop box has a thickness of less than 125 mm, preferably less than 100 mm.

8. A harvester head with a control arrangement of a collector-conveyor organ mounted on the harvester head for transporting harvested material poured into the collector-conveyor organ towards a gathering channel located in a middle area between both sides of the harvester head and through which the transported harvested material exits; characterized in that the control arrangement comprises a train of transmission stages extending from a power outlet in the rear part of the harvester head, at a lower level than the gathering channel, surrounding the gathering channel towards a point below located above the collector-conveyor organ, from where low in order to take the collector-trans-carrier.

9. The harvester head of claim 8, wherein said train of transmission stages comprises:
a first drive shaft located behind the collector-conveyor member and provided for coupling to a power outlet;
a horizontal-to-vertical direction-changing mechanism located towards one side of the gathering channel and comprising a receiving wheel coupled to said first drive shaft and a transmitter wheel linked to said receiving wheel and arranged in a vertical direction higher and forward relative to the receiving wheel;
a vertical-to-horizontal direction-changing mechanism comprising a second drive shaft oriented in a horizontal direction and parallel to the collector-conveyor organ, at a greater height than the collector-conveyor organ, towards a middle area of the harvester head and having a receiving end co-connected to said transmitting wheel; and
a last transmission stage (54) connected to a transmitter end of the second transmission shaft and which is lowered to take the collector/conveyor organ.

10. The harvester head of claim 9, wherein the first drive shaft is disposed transverse to the forward direction.

11. The harvester head of claim 9, wherein the receiving and transmitting wheels consist of pulleys arranged in a vertical plane that are linked by a belt, the receiving wheel being mounted on a horizontal inter-medial shaft mounted between two supports of a vertical structure attached to the chassis of the head to one side of the gathering channel, the intermediate shaft having an end protruding from the support structure and connected by means of a universal joint to said first transmission shaft.

12. The harvester head of claim 11, charged by an additional receiving pulley mounted on said intermediary shaft and linked by another belt to an additional transmitting pulley arranged in a vertical plane and mounted on a lower shaft mounted horizontally between said supports of the vertical structure to distribute driving force from the first shaft and the intermediate shaft to a control branch of a cutting bar in the harvester head.

13. The harvester head of claim 11, wherein the last transmission stage provides a fixed speed reduction and equates to at least 80% of the total rotation speed reduction provided by the control arrangement and at least one of the receiving or transmitting wheels is re-changeable by a kit to adapt the head at different speeds of the power outlet.

14. The harvester head of claim 9, wherein the second drive shaft is oriented horizontally and parallel to the collector-conveyor organ towards a middle area of the harvester head where it has the transmitting end penetrating inside a drop box of the last transmission stage.

15. The harvester head of claim 14, wherein the drop box and the receiving end of the second drive shaft are mounted to the rack fixed to the chassis of the crop head.

16. The harvester head of claim 8, wherein the collector-conveyor member comprises an auger assembly about an axis of rotation mounted within a tray extending transversely to the forward direction of the head and into which it is poured the harvested material where it is transported by the auger assembly towards the gathering channel formed by an opening in the rear wall of the tray in said middle area of the harvester head through which the transported harvested material exits.

17. The harvester head of claim 16, wherein said collector-conveyor member comprises two collinear augers, each of which has an outer end supported on a side arm of the harvester head chassis and an inner (medial) end in said middle zone mechanically connected to the transmission drop box.

18. The harvester head of claim 17, wherein both of the augers are mounted on a same through-axis within an output gear in the drop box.

19. The harvester head of claim 18, wherein said through-axis has a polygonal section that couples it for rotation integral with said through-axis.

20. The harvester head of claim 16, comprising a baffle formed in the inner end blade of each auger, contiguous to the control drop box.

21. The harvester head of claim 20, wherein each baffle comprises a finger attached to the transfer face of said inner end blade of the auger where the mouth faces the straddling unit and which extends straight at an angle of 30° with respect to the radial by approximately the number of its path and takes an additional angle of 15° in the outer third thereof tending to its parallelism with the tangent of the circumference of the auger.

22. A multistage gear control box, usable in a control arrangement of a harvester head of claim 8, comprising at least three parallel axes comprising an input shaft for receiving a rotation angle, an output shaft for coupling to a collector-conveyor member penetrating inside it and at least one intermediate shaft located between the foregoing, and at least two reduction-in-garage reducing stages by means of which the output shaft is connected to the input shaft through said at least one intermediate shaft for transmitting said spin-off rotation to the collector-conveyor, wherein the at least two gear-reducing stages are housed with said at least three axes in a thin housing of less than 125 mm thick and the gears of at least the garages mounted on the intermediate shaft have female threads by means of which the at least two gear-reducing stages are housed with said at least three axes in a thin housing of less than 125 mm thick and the gears of at least the garages mounted on the intermediate shaft have female threads by means of which the gears are fixed to the respective shaft by threading and glued with an adhesive.

23. The control box of claim 22, wherein the thickness of the housing is less than 100 mm.

24. The control box of claim 22, wherein said gears are threaded and glued to hubs which, in turn, are fixed solidly to the respective shaft by means of a splined system.

25. The control box of claim 22, wherein said gears are threaded onto male threads formed on the respective shaft.

26. The control box of claim 24, wherein the rotational directions of the threads are counter to the normal working direction of rotation of each threaded gear to prevent the gears from unthreading as they rotate in the normal working direction.

27. The control box of claim 22, comprising a separator, such as a Seger ring fitted into a groove, between the intermediate gears to retain them in position.

28. The control box of claim 22, wherein the intermediate gears are held in place by a threaded sleeve on the common hub, introduced into a machined recess in the gears.

29. The control box of claim 22, wherein the gears have helical teeth and the intermediate gears on the same axis have opposite propellers.

30. The control box of claim 22, wherein it is a gearbox with a transmission ratio of at least 5:1.
